(19) United States
(12) Patent Application Publication
(10) Pub. No.: US 2004/0198130 A1
(43) Pub. Date: Oct. 7, 2004

(54) Method of manufacturing plasma display panels and baking panel device used for the method

(76) Inventors: Hiroyasu Tsuji, Osaka (JP); Makoto Morita, Hyogo (JP); Masanori Suzuki, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/479,252

(22) PCT Filed: Jun. 9, 2003
(86) PCT No.: PCT/JP03/07254

(30) Foreign Application Priority Data
Jun. 12, 2002 (JP) 2002-170886

(51) Int. Cl. H01J 9/38; H01J 9/24

(52) U.S. Cl. 445/24

(57) ABSTRACT

A method of manufacturing plasma display panels and a firing device that allows preferable firing of panel components by cleaning each setter. Cleaning means 105 provided in lower passage 23c allows removal and cleaning of abrasion powder generated while setter 103 is transported by rotation of rollers 22a, 23a, and 24a. This reduces attachment or mixing of abrasion powder to a panel component.

### TECHNICAL FIELD

The present invention relates to methods of manufacturing plasma display panels (PDPs) which are characterized as large-screen, thin, and lightweight display devices, and firing devices employed in their manufacture.

### BACKGROUND ART

PDPs are gaining more attention recently as flat display panels since they have more advantageous features than liquid crystal panels, including faster display time, wider viewing angle, ease of manufacturing large screens, and higher display quality realized by self-light emission. PDPs are being used in an expanding range of contexts, including as displays for public places and wide-screen display devices for domestic viewing.

In a PDP, gas discharge generates ultraviolet rays, and these ultraviolet rays excite the phosphors, which then emit visible light for color display. PDP driving systems can be generally classified into AC and DC types. The electric discharge system can be classified into two types: surface discharge and opposed discharge. The AC surface discharge type that has a 3-electrode structure is the mainstream type with respect to higher definition, larger screens, and easier manufacture. The PDP of the AC surface discharge type that has a 3-electrode structure is configured with multiple pairs of display electrodes aligned in parallel on one substrate, address electrodes disposed on the other substrate in a way such that to cross the display electrodes, a barrier rib, and a phosphor layer. Since the phosphor layer can be made relatively thick, this type of PDP is appropriate for color displays using phosphors.

The method of manufacturing PDPs includes the steps of forming panel components such as electrode, dielectric and phosphor one after another mainly using the step of forming a thick film on the surface of the front substrate and rear substrate by repeating printing, drying and firing; and overlaying and sealing the front substrate and rear substrate on which these panel components are formed. In the above steps, a firing device is used for drying and firing.

As for the firing device, a so-called roller-hearth kiln, fit for mass production, is employed. The roller-hearth kiln has its transportation means configured by aligning multiple rollers in the direction of transportation of the substrate. While firing the panel components formed on the front and rear substrates, the substrates are placed on a support substrate called a setter (this state is hereafter called the firing target) during transportation for firing to prevent damage to each substrate by the transportation means.

The quality of panel components greatly affects the display characteristic of PDP images. Accordingly, a firing process and firing device which prevent attachment or mixing of foreign particles to the panel components are demanded.

However, foreign particles are attached or mixed to the fired panel components when a conventional firing device is employed for firing. This causes, for example, variations in the resistance if the panel components are metal-wired, resulting in low yield for PDPs. One of causes of foreign particles is abrasion powder generated by friction between the setter and roller at transporting the firing target on the rollers. This abrasion powder attaches mainly on the face of setter contacting the roller. The setter transported in this condition scatters the abrasion powder in the entire firing device. Consequently, defects due to the abrasion powder occurs frequently.

The present invention is designed to solve this disadvantage, and aims to offer a method of manufacturing PDPs and a firing device employed in the manufacture that reduce attachment or mixing of abrasion powder generated by friction between the roller and setter to the panel components.

### DISCLOSURE OF INVENTION

To achieve the above object, the method of manufacturing PDPs of the present invention includes the steps of firing a substrate at a predetermined temperature while the substrate on which panel components are formed is placed on a setter and transported by a transportation means configured with multiple rollers; and cleaning the setter

This method allows reduction of attachment or mixing of abrasion powder generated by friction between the roller and setter to the panel components. Accordingly, the method of manufacturing PDPs and the firing device that allow preferable firing is achievable.

### BRIEF DESCRIPTION OF THE DRAWINGS

FIG. 1 is a sectional perspective view of a PDP structure.

FIG. 2 is a process chart of a method of manufacturing PDPs in accordance with an exemplary embodiment of the present invention.

FIG. 3 is a sectional view of a structure of a firing device for PDPs in accordance with the exemplary embodiment of the present invention.

FIG. 4 is a sectional view of a structure of a cleaning means in the firing device for PDPs in accordance with the exemplary embodiment of the present invention.

### DETAILED DESCRIPTION OF PREFERRED EMBODIMENT(S)

An exemplary embodiment of the present invention is described below with reference to drawings.

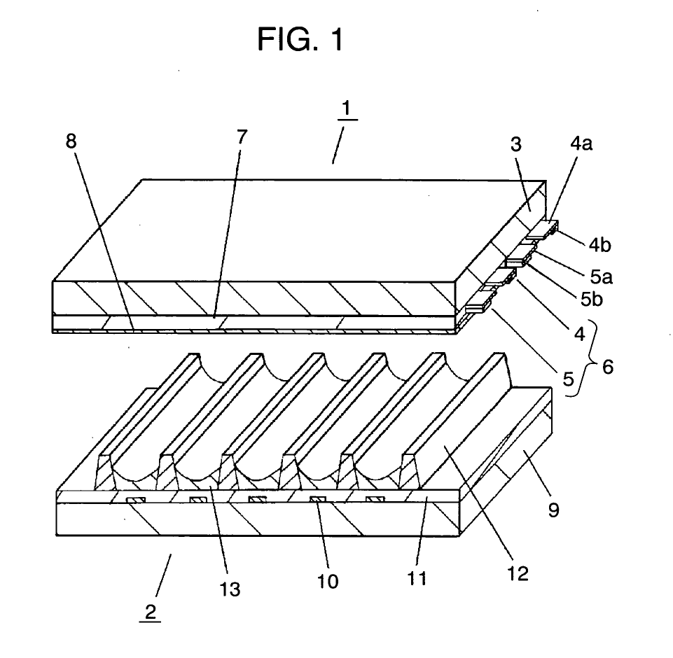

FIG. 1 shows the structure of a PDP manufactured using a method of manufacturing PDPs of the present invention. The PDP is configured with front substrate 1 and rear substrate 2. Front substrate 1 consists of striped display electrode 6 including a pair of scanning electrode 4 and sustain electrode 5 formed on transparent insulating substrate 3 such as a glass substrate made of borosilicate sodium glass using the float process, dielectric layer 7 covering display electrodes 6, and protective film 8 made of MgO formed on dielectric layer 7. Scanning electrode 4 and sustain electrode 5 are, for example, configured by transparent electrodes 4a and 5a made of a transparent conductive material such as ITO and bus electrodes 4b and 5b made such as of Ag which are electrically coupled to these transparent electrodes 4a and 5a.

Rear substrate 2 consists of address electrode 10 formed in a direction orthogonal to display electrode 6 on substrate 9 in a way facing substrate 3 of front substrate 1, dielectric layer 11 covering this address electrode 10, multiple striped barrier ribs 12 parallel to and between address electrodes 10 on dielectric layer 11, and phosphor layer 13 formed between these barrier ribs 12. For color display, red, green, and blue are in general disposed sequentially in phosphor layers 13.

Sealing member (not illustrated) forms a seal around front substrate 1 and rear substrate 2 such that display electrode 6 and address electrode 10 cross at right angles and that a small discharge space is secured in between. In the discharge space, discharge gas such as a mixture of neon (Ne) and xenon (Xe) is enclosed. The discharge space is partitioned into multiple blocks by barrier ribs 12. Multiple discharge cells are thus formed between barrier ribs 12, and these discharge cells are unit luminescence regions.

Electric discharge occurs as a result of the voltage periodically applied to address electrode 10 and display electrode 6. The ultraviolet rays generated by this electric discharge irradiate phosphor layer 13, where they are converted to visible light for image display.

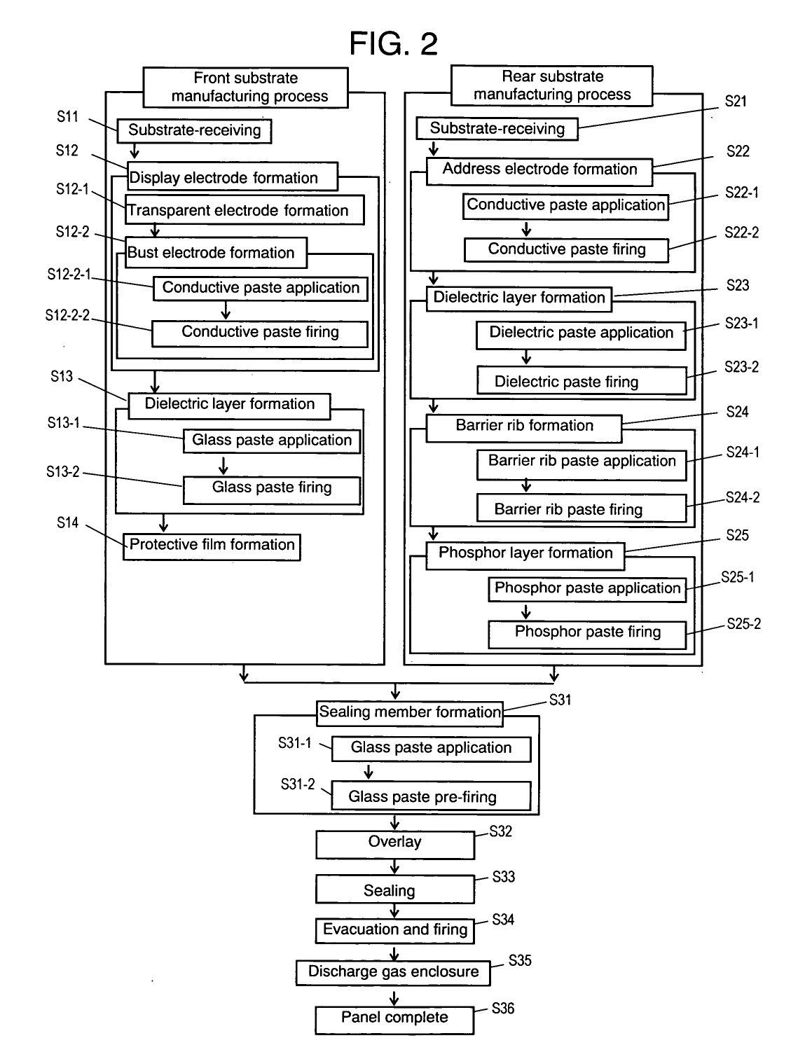

Next, the method of manufacturing the PDP as configured above is described with reference to FIG. 2, which shows the steps in the method of manufacturing PDPs in the exemplary embodiment of the present invention.

First, the process of manufacturing the front substrate, i.e., front substrate 1, is described. After the substrate-receiving step (S11) to receive substrate 3, the step of forming display electrodes (S12) is executed to form display electrodes 6 on substrate 3. The step of forming display electrodes (S12) includes the step of forming transparent electrodes (12-1) for forming transparent electrodes 4a and 5a, and the subsequent step of forming bus electrodes for forming bus electrodes 4b and 5b. The step of forming bus electrodes (S12-2) includes the step of applying conductive paste (S12-2-1) for applying conductive paste such as Ag by screen-printing and the step of firing conductive paste (S12-2-2) for firing the conductive paste applied. Then, after the step of forming display electrodes (S12), the step of forming dielectric layer (S13) is executed to form dielectric layer 7 to cover display electrodes. The step of forming dielectric layer (S13) includes the step of applying glass paste (S13-1) for applying paste including lead-system glass material [whose composition is, for example, 70 wt % lead oxide (PbO), 15 wt % boron oxide (B₂O₃), and 15 wt % silicon oxide (SiO₂)] by screen-printing, and the step of firing glass paste (S13-2) for firing the glass material applied. Then, the step of forming protective film (S14) is executed to form protective film 8 such as of magnesium oxide (MgO) by vacuum deposition on the surface of dielectric layer 7 to complete the manufacture of front substrate 1.

Next, the process of manufacturing the rear substrate, i.e., rear substrate 2, is described. After the step of receiving (S21) for receiving substrate 9, the step of forming address electrodes (S22) is executed to form address electrodes 10 on substrate 9. This step (S22) includes the step of applying conductive paste (S22-1) for applying conductive paste such as of Ag by screen-printing, and a subsequent step of firing the applied conductive paste (S22-2). The step of forming dielectric layer (S23) is then executed to form dielectric layer 11 on address electrode 10. This step (S23) includes the step of applying dielectric paste (S23-1) for applying dielectric paste containing titanium oxide (TiO₂) particles and dielectric glass particles typically by screen-printing, and a subsequent step of firing the applied dielectric paste (S23-2). Then, the step of forming barrier ribs (S24) for forming barrier ribs 12 on dielectric layer 11 between address electrodes 10 is executed. This step (S24) includes the step of applying barrier paste (S24-1) for applying barrier paste containing glass particles typically by printing and a subsequent step of firing barrier paste (S24-2) for firing the applied barrier paste. The step of forming phosphor layer (S25) for forming phosphor layer 13 between barrier ribs is then executed. This step (S25) includes the step of applying phosphor paste (S25-1) for making color phosphor paste of red, green, and blue, and applying the phosphor paste of these colors between barrier ribs 12, and the subsequent step of firing the applied phosphor paste (S25-2). Rear substrate 2 is completed through these steps.

Next, the step of sealing front substrate 1 and rear substrate 2 manufactured as above and the step of evacuating and enclosing discharge gas are described.

A step of forming sealing member (S31) for forming sealing member made of glass frit on one or both of front substrate 1 and rear substrate 2 is executed. This step (S31) includes the step of applying glass paste for sealing (S31-1) and the step of pre-firing glass paste (S31-2) for tentatively firing the applied glass paste to remove the resin constituent in the glass paste applied. Then, the overlaying step (S32) is executed to overlay two substrates such that display electrodes 6 on front substrate 1 and address electrodes 10 on rear substrate 2 cross at right angles. The sealing step (S33) is then executed to soften the sealing member by heating both substrates overlaid for sealing. After the evacuating and firing step (S34) is executed to fire the panel while evacuating a small discharge space created between the sealed substrates, the step of enclosing discharge gas (S35) is executed to enclose discharge gas under a predetermined pressure so as to complete the PDP (S36).

In the manufacture of the PDP, as described above, a firing process is often applied when forming panel components such as bus electrodes 4b and 5b, dielectric layer 7, address electrode 10, dielectric layer 11, barrier rib 12, phosphor layer 13, and sealing member (not illustrated). A firing device employed in these firing processes is described below.

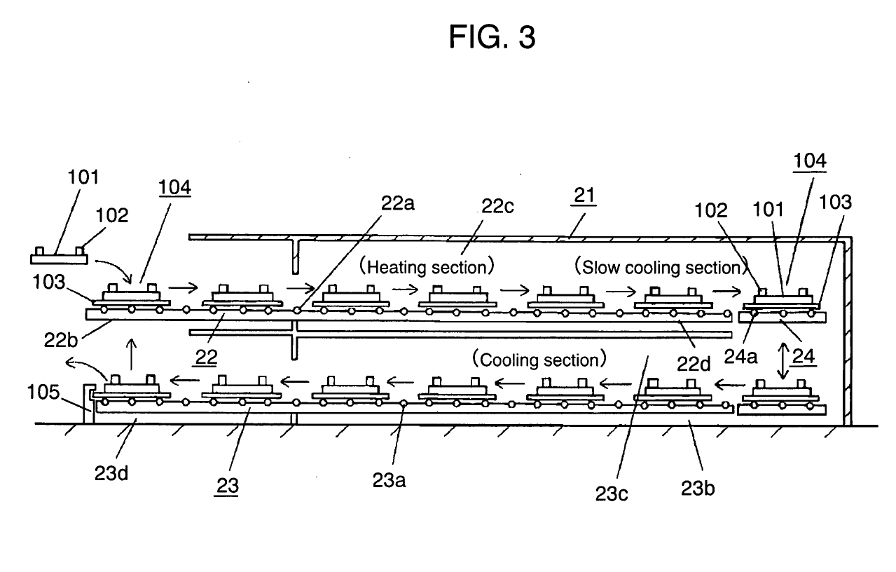

FIG. 3 is a sectional view of the firing device used in the method of manufacturing PDPs in the exemplary embodiment of the present invention. Firing device 21 includes outward transportation means 22 in which multiple rollers 22a are aligned in the transporting direction, return transportation means 23 in which multiple rollers 23a are aligned in the transporting direction, and elevating means 24 in which multiple rollers 24a are aligned in the transporting direction and also configured so as to enable rollers 24a to be elevated between outward transportation means 22 and return transportation means 23.

Substrate 101, i.e., front substrate 1 or rear substrate 2, of the PDP on which panel components 102 such as bus electrodes 4b and 5b, dielectric layer 7, address electrode 10, dielectric layer 11, barrier rib 12, phosphor layer 13, or sealing member (not illustrated) are formed is placed on setter 103 which is a support substrate, and transported by outward transportation means 22. Setter 103 is provided so as to prevent damage to substrate 101. A structure in which substrate 101 is placed on setter 103 is hereafter called firing target 104.

In the above configuration, characteristic of the exemplary embodiment is that cleaning means 105 for cleaning setter 103 is provided. As shown in FIG. 3, abrasion powder is generated by friction between rollers 22a, 23a and 24a and setter 103 while setter 103 is transported by rotation of rollers 22a, 23a, and 24a. This generated abrasion powder attaches to the contacting face (rear face hereafter) of setter 103. In the exemplary embodiment of the present invention, cleaning means 105 is provided, for example, inside lower passage 23c for cleaning the rear face of setter 103.

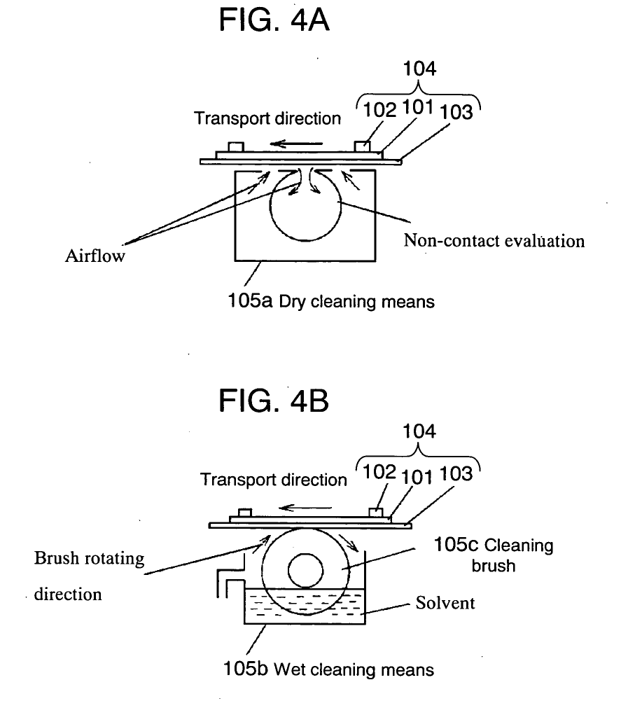

FIG. 4 shows a sectional view of the structure of the cleaning means in the firing device for PDPs in the exemplary embodiment of the present invention. Examples of cleaning means 105 are dry cleaning means 105a shown in FIG. 4A and wet cleaning means 105b shown in FIG. 4B.

Dry cleaning means 105a shown in FIG. 4A cleans off foreign particles attached to the rear face of setter 103 without contacting setter 103 by lifting away foreign particles by means of an air current generated by suction. Since this is a cleaning method that attracts foreign particles, rather than blowing them off by air blast, setter 103 can be cleaned effectively without any detrimental effects on the ambient atmosphere, such as causing foreign particles to scatter or float in midair.

Moreover, for further effectively removing foreign particles on the rear face of setter 103, the airflow on the rear face of setter 103 is preferably applied in the direction shown by the arrow in FIG. 4A, i.e., along the planar direction of the rear face of setter 103 by suction.

Wet cleaning 105b shown in FIG. 4B cleans the rear face of setter 103 using an organic or inorganic solvent. FIG. 4B shows cleaning of the rear face of setter 103 by rotation of cleaning brush 105c. Although an example of using cleaning brush 105c is shown in FIG. 4B, a structure that blows solvent onto the rear face of setter 103 without using cleaning brush 105c is also feasible.

In wet cleaning, cleaning is insufficient if temperature T1 (° C.) of setter 103 is higher than boiling point T2 (° C.) of the solvent, because the solvent evaporates instantaneously. On the other hand, if temperature T1 is too low, slow drying of the solvent has a detrimental effect, due in some cases to moisture. Accordingly, the relationship between temperature T1 (° C.) of setter 103 and boiling point T2 (° C.) of the solvent is preferably set to a range where the solvent does not boil and evaporate but instead dries and evaporates easily. For example, the temperature relation in which setter 103 dries in about 5 minutes after cleaning is preferable. The experiment suggests that this kind of temperature relation is achieved specifically when temperature T1 (° C.) of setter 103 and boiling point T2 (° C.) of the solvent satisfy the following conditions: 0.9×T2≦T1<T2. Cleaning under these temperature conditions enables natural drying of the solvent after cleaning, eliminating the need for a drying process and device for setter 103. To satisfy the above temperature conditions, wet cleaning 105b can be provided in any area of the firing device where setter 103 reaches the temperature required.

The firing process employing firing device 21 provided with the cleaning means for setter 103 is described next with reference to FIG. 3. First, firing target 104 is placed on transport start 22b of outward transportation means 22. Outward transportation means 22 guides firing target 104 to upper passage 22c of firing device 21, and heating means such as a heater (not illustrated) provided inside upper passage 22c heats firing target 104 to a predetermined firing temperature in the heating section for firing, while the firing target continues to be transported by outward transportation means 22. Then, in a slow-cooling section, firing target 104 is cooled while being transported toward end 22d of outward transportation means 22. Firing target 104 is further transported beyond transport end 22d of outward transportation means 22, and reaches elevating means 24. Firing target 104 reaching elevating means 24 is lowered to the level connected to return transportation means 24 by elevating means 24, and transferred to transport start 23b of return transportation means 23 by being transported in the reverse direction to the transportation direction of outward transportation means 22. Then, return transportation means 23 transports firing target 104 in lower passage 23c, i.e., the cooling section, to cool firing target 104 to normal temperature. Cleaning means 105 is installed inside lower passage 23c.

Since cleaning means 105 cleans the face of setter 103 contacting rollers 22a, 23a, and 24a, foreign particles such as abrasion powder that is generated and becomes attached to setter 104 by contact of setter 103 with rollers 22a, 23a, and 24a during transportation are removed. When firing target 104 reaches transport end 23d of return transportation means 23, fired substrate 101 is taken out from setter 103. Empty setter 103 moves to transport start 22b of outward transportation means 22 in the upper stage again, and next substrate 101 is placed and guided into upper passage 22c for firing.

Here, firing device 21 employed in the method of manufacturing PDPs in the exemplary embodiment as described above allows elimination of foreign particles such as abrasion powder generated by contact of rollers 22a, 23a, and 24a and setter 103 and which become attached to the rear face of setter 103 during transportation. Accordingly, the risk of foreign particles attached to setter 103 being scattered over firing device 21 is eliminated when setter 103 is used for firing the next substrate. Attachment or mixing of foreign particles with panel components 102 is thus prevented. This makes the quality of the panel components uniform, and allows the manufacture of PDPs at high yield.

In the exemplary embodiment, cleaning means 105a or 105b is installed inside lower passage 23c which is return transportation means 23 of firing device 21. This prevents foreign particles from becoming suspended in the air in upper passage 22c where substrates before panel components are fired and solidified are transported, enabling the manufacture of even higher quality PDPs.

The exemplary embodiment describes the case of providing one cleaning means. However, two or more dry cleaning or wet cleaning means can be provided in different parts of the process. In particular, if wet cleaning means is provided in the upstream of the transportation and dry cleaning means is provided in its downstream, the temperature can be more effectively controlled relative to the boiling point of the solvent.

### INDUSTRIAL APPLICABILITY

As described above, the present invention reduces attachment or mixing of abrasion powder generated by friction between the roller and setter to the panel components. This achieves the method of manufacturing PDPs and the firing device used in the manufacture that enables preferable firing of panel components.

1. A method of manufacturing a plasma display panel, said method comprising:
firing a panel component at a predetermined temperature while transported by transportation means configured with a plurality of rollers, said panel component being formed on a substrate, and said substrate being placed on a setter; and
cleaning said setter.

2. A method of manufacturing a plasma display panel comprising:
an outward step of firing a panel component at a predetermined temperature while transported by transportation means configured with a plurality of rollers, said panel component being formed on a substrate, and said substrate being placed on a setter;
a return step of transporting said fired panel component by transportation means configured with a plurality of rollers, said panel component being formed on the substrate, and said substrate being placed on the setter; and
a step of cleaning said setter in said return step.

3. The method of manufacturing a plasma display panel as defined in claim 1, wherein said step of cleaning employs wet cleaning means using a solvent for cleaning.

4. The method of manufacturing a plasma display panel as defined in claim 3, wherein temperature T1 (C°) of the setter and boiling point temperature T2 (C°) in said step of cleaning have a relation of 0.9×T2≦T1<T2.

5. The method of manufacturing a plasma display panel as defined in claim 1, wherein said step of cleaning employs dry cleaning means using air evacuation for cleaning.

6. The method of manufacturing a plasma display panel as defined in claim 5, wherein said air evacuation generates airflow along a planar direction of the setter.

7. The method of manufacturing a plasma display panel as defined in claim 1, wherein a face of the setter contacting the rollers is cleaned.

8. A firing device for a plasma display panel comprising:
transportation means configured by aligning at least a plurality of rollers in a transport direction of a substrate;
firing means for heating and firing the substrate on which a panel component is formed while said substrate placed on a setter is transported by said transportation means; and
cleaning means for cleaning said setter.

9. A firing device for a plasma display panel comprising:
outward transportation means configured by aligning at least a plurality of rollers in a transport direction of a substrate;
return transportation means configured by aligning a plurality of rollers in the transport direction of the substrate;
firing means for heating and firing the substrate on which a panel component is formed while said substrate placed on a setter is transported by said transportation means; and
cleaning means for cleaning said setter, said cleaning means being provided in said return transportation means.

10. The firing device for a plasma display panel as defined in claim 8, wherein said cleaning means is wet cleaning means using a solvent.

11. The firing device for a plasma display panel as defined in claim 10, wherein said wet cleaning means is provided at a position where temperature T1(C0) of the setter and boiling point T2 (C0) of the solvent satisfies a relation of 0.9×T2≦T1<T2.

12. The firing device for a plasma display panel as defined in claim 8, wherein said cleaning means is dry cleaning means using air evacuation.

13. The firing device for a plasma display panel as defined in claim 12, wherein said air evacuation generates airflow along a planar direction of the setter.

14. The firing device for a plasma display panel as defined in claim 8 to 13, wherein a face of the setter contacting the roller is cleaned.

15. The method of manufacturing a plasma display panel as defined in claim 2, wherein said step of cleaning employs wet cleaning means using a solvent for cleaning.

16. The method of manufacturing a plasma display panel as defined in claim 2, wherein said step of cleaning employs dry cleaning means using air evacuation for cleaning.

17. The method of manufacturing a plasma display panel as defined in claim 2, wherein a face of the setter contacting the rollers is cleaned.

18. The firing device for a plasma display panel as defined in claim 9, wherein said cleaning means is wet cleaning means using a solvent.

19. The firing device for a plasma display panel as defined in claim 9, wherein said cleaning means is dry cleaning means using air evacuation.

20. The firing device for a plasma display panel as defined in claim 9, wherein a face of the setter contacting the roller is cleaned.
